(19) United States
(12) Patent Application Publication
(10) Pub. No.: US 2017/0298756 A1
(43) Pub. Date: Oct. 19, 2017

(54) Stand Alone Hydro Electric Power Supply System

(71) Applicant: Tunji Laro, Secaucus, NJ (US)

(72) Inventor: Tunji Laro, Secaucus, NJ (US)

(21) Appl. No.: 14/155,369

(22) Filed: Jan. 15, 2014

(51) Int. Cl. F01D 13/00; F01D 15/10; H02K 7/18; F03B 17/00

(52) U.S. Cl. CPC F01D 13/00; H02K 7/1823; F01D 15/10; F03B 17/005; Y10S 415/916

(57) ABSTRACT

A “Hydro Electric Power Supply System” that comprises an upper water tank and a lower water tank. The tanks are positioned where the said upper water tank is placed above the said lower water tank to create a necessary water flow from top to bottom. Also used is a water pump; a first turbine to generate electricity dedicated to power the water pump so as to extract water from said lower water tank back up to said upper water tank. There is also the ability within this device for a second turbine to generate electricity for consumer usage. A plurality of pipes are also incorporated so as to create water passages between said upper water tank, said first and second turbine, and said water pump.

### BACKGROUND OF THE INVENTION

### Field of the Invention

The present invention relates to a hydroelectric power generating system, more particularly related to a stand-alone off grid micro-hydroelectric power generating system.

### Description of Related Art

Hydroelectric power is widely used by many major utility suppliers in the form of large hydroelectric dams. However, all the hydroelectric dams won't help provide power to a home or village outside the reach of the electric power grid. Therefore, much smaller scale power generation exits for home and business which are out of reach of national grid depending on what type of natural resources available within reachable distance.

For a place lucky enough to have a source of consistent moving water source nearby, “micro-hydro” power is an option for gathering electricity. It is a small-scale harnessing of energy from force of running water such as steep mountain rivers, also referred as “Run of the River”. Micro-hydro power generating plants can use small water turbines fed from a river or stream to generate power for homes, hospitals, schools, office buildings and workshops, no matter how far from the utility power grid they may be.

Such systems do not require the construction of a dam to form a river water storage facility (a water reservoir). Instead they divert water from the stream or river, channel through a settling basin which helps to remove sediments that could harm the turbine. Water then being channeled into the forebay tank where it is directed downhill through a pressurized pipe called a penstock. When the water reaches the bottom, it drives a specially designed turbine and generator to produce electricity.

By not requiring an expensive dam for water storage, a “Run of the River” system requires less cost to be constructed and to produce power. It also can avoid the damaging environmental and social effects that larger hydroelectric schemes cause, including the risk of flooding or earthquake.

However, not everyone is lucky enough to have source of running water near their homes or businesses. A reliable water source is desirable for micro hydro power generation system when no natural water source is available.

### SUMMARY OF THE INVENTION

Therefore, it is one objective of present invention to create a micro hydro power generation system for home and business having no source of natural running water close by.

In an exemplary embodiment of the present invention, a “Hydro Electric Power Supply System” (Hereunder referred as “HELPS” system) is designed to implement above mentioned solution.

“HELPS” system comprises an upper water tank, a lower water tank, said upper water tank is placed above said lower water tank to create necessary water head; a first turbine to generate electricity for consumer usage; a second turbine to generate electricity dedicated to pump the water from said lower water tank back up to said upper water tank; a water pump powered by said second turbine.

In one aspect of the embodiment, an upper water tank is placed at least a minimum of 20-30 feet above ground, either on the roof of a building or on free standing support. A lower water tank is positioned below the upper tank to collect water from the upper tank. A plurality of water pipes runs from the bottom of the upper water tank down to the lower tank. Water from each pipe will pass through turbine wheels driving the generator to produce electricity.

In another aspect of the embodiment, each pipe reduces in diameter as it gets closer to the turbine. Or else a dedicated pipe reducer may be connected to the pipes before going into turbine inlets. This is to increases the water pressure/force exiting the pipe and striking the wheels in the turbine. Water flowing through the turbines is collected in the lower tank. One of the turbines will be dedicated to power a water pump which is used to pump the water collected in the lower tank back to the upper tank. The other turbine(s) is/are used to produce electricity for the general usage.

In yet another aspect of the embodiment, the water pump pumps water to the upper tank at a rate equal to the rate of water falling through plurality of pipes into the lower tank. The size of the lower tank can be less than the size of the upper tank as long as the water collected in the lower tank is pumped back up at the same rate of water flowing into the lower tank.

In another embodiment, a configuration with more than two turbines also is available, which allows for more than one turbine to produce electricity for the home or business' general use. A higher capacity water pump will be employed to accommodate the increased volume of water collecting in the lower tank.

The system is pre-filled with clean filtered water to prevent or minimize pipe corrosion and damage to the turbines.

Electronic and float switches are used to control shut-offs in case of emergency. In the event of the water pump failing, to prevent water from overflowing the lower water tank, the system includes a mechanism that triggers the shutoff of turbines and close water inflow pipes and thereby stopping water from continuing to enter through the turbines.

In the event where said second turbine supplying consumer electricity fails, system also includes an emergency shutoff dedicated to turbines and/or generators. The emergency shutoff is operated manually to shut off the system.

In another embodiment of the present invention, turbines and lower water tank may be placed under ground to prevent overheating in warmer climates. By doing so, it will help to cool the water passing through the turbines as well as lessen the noise of the turbines and water flow. This also reduces the required height of upper water tank.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a system configuration diagram of one embodiment of present invention;

FIG. 2 is a functional diagram of one embodiment of present invention.

### DESCRIPTION OF THE PREFERRED EMBODIMENT

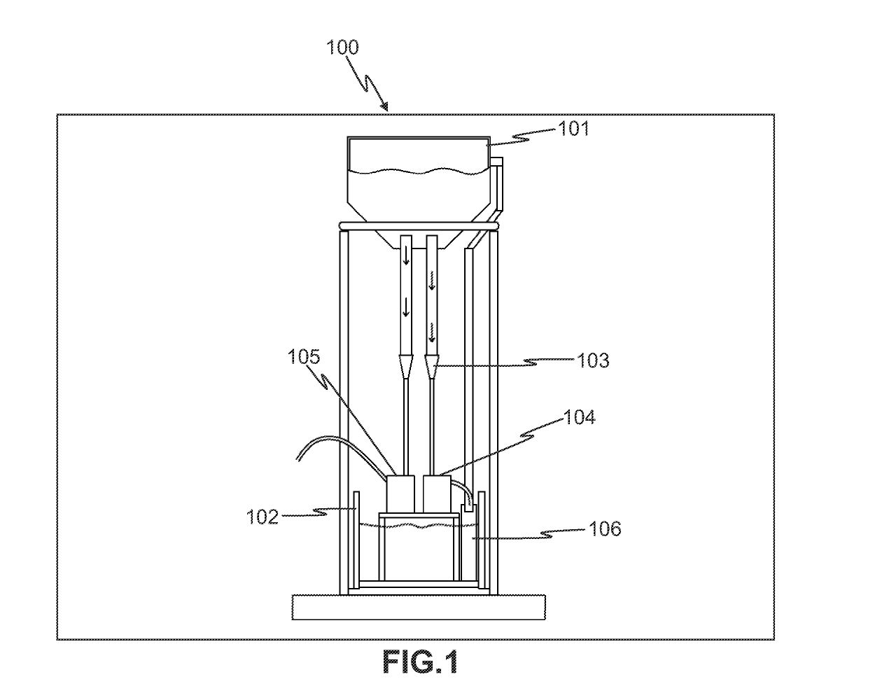

FIG. 1 shows a system diagram for one embodiment of the present invention. A “Hydro Electric Power Supply System” 100 comprises an upper water tank 101, a lower water tank 102, said upper water tank 101 is placed above said lower water tank 102 to create necessary water head; a water pump 106; a first turbine 104 to generate electricity dedicated to power said water pump to extract water from said lower water tank 102 back up to said upper water tank 101; a second turbine 105 to generate electricity for consumer usage; and a plurality of pipes to form water passage ways between said upper water tank, said first and second turbine, and said water pump.

Referring to FIG. 1, upper water tank 101 is placed 20-30 feet above ground, either on the roof of a building or on free standing support. Lower water tank 102 is positioned below the upper tank to collect water from the upper tank. A minimum water head is created to power up the turbine runners. Turbines 104 and 105 and lower water tank 102 may be placed under ground to prevent overheating in warmer climates. By doing so, it may help to cool the water passing through the turbines as well as lessen the noise of the turbines and water pump. It may also reduce the required height of the water tank above the ground.

Each water pipe runs from the bottom of upper tank 101 and connects to a pipe reducer 103. The diameter of said pipe reducer 103 is in line with the diameters of water inlets of said turbines 104 and 105. The pressure coming out of pipe reducer 103 will increase significantly to create a high speed water jet. It strikes the turbine runners to drive the generator producing electricity. Alternatively, to obtain a high speed water jet, each pipe can reduce in diameter as it gets closer to water inlets of said turbines 104 and 105.

Water flowing through the turbines 104 and 105 is collected in lower tank 102. For the sake of illustration, Turbine 104 is dedicated to generate electricity for AC and DC loads. Turbine 105 is dedicated to power a water pump 106. Water pump 106 is used to pump the water collected in lower water tank 102 back to upper water tank 101. So that there is always enough water in upper water tank 101 to run through said turbines 104 and 105. Water pump 106 can be connected to the system backup power supply (either a battery bank or a diesel generator or both, not shown in FIG. 1) in case that turbine 105 fails to produce electricity.

Water pump 106 pumps water up back into upper tank 101 at a rate equal to the rate of water falling through the pipes down into lower tank 102. The size of lower tank 102 is the same as size of upper water tank 101. It can be less than the size of the upper tank 101 as long as the water collected in lower tank 102 is pumped back up at the same rate of water flowing into it. Lower water tank 102 is configured with overflow discharge channel (not shown) in case of unprepared pump failure.

“HELPS” System 100 is pre-filled with clean filtered water to prevent or minimize pipe corrosion and damage to the turbines. Upper water tank 101 can be supplied with alternative reliable water sources such as city or county water, underground water. Such water intake is needed to prevent water loss during daily operation.

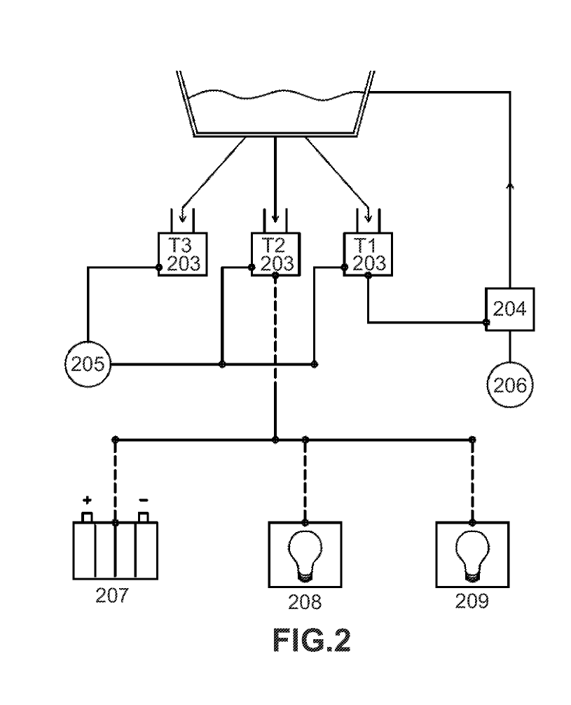

FIG. 2 shows a functional diagram of one embodiment of present invention. As shown in FIG. 2, electricity output of turbine 201 is provided to power up water pump 204 in a known way. The water pump 204 is configured to match the speed of water inflow and outflow.

Electricity output of turbine 202 is supplied to power up home or business applications. Turbine 202 is electrically connected to a battery bank 207, AC loads 208 and DC loads 209. The details of connection are commonly known, and an example of which may be found in the following link http://www.eeca.govt.nz/sites/all/files/power-from-the-people-microgen-guide-nov2010.pdf, therefore is incorporated in the entirety by reference.

As shown in FIG. 2, in another embodiment according to present invention, a configuration with more than two turbines is available. Turbine 202 and turbine 203 both generate electricity for home or business general use. A higher capacity water pump 204 can be employed to accommodate increased volume of water collecting in the lower water tank.

In the event of the water pump failing, to prevent water from overflowing the lower water tank, the system includes an electronic and float switches mechanism 205, which trigger the shutoff of turbines and close water inflow pipes thereby stopping water from continuing through the turbines 201, 202 and 203.

In the event where said turbine 202 or/and 203 fails, an emergency shutoff 205 is connected to each individual turbine in a known fashion. The emergency shutoff 205 can be operated manually to shut off the system to avoid risk of lower water tank overflowing.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

Additional general background, which helps to show variations and implementations, may be found in the following patent application publications, all of which are hereby incorporated by reference herein for all purposes U.S. Pat. No. 6,774,608 to disclose a turbine driven power generating system.

The claims as filed are intended to be as comprehensive as possible, and NO subject matter is intentionally relinquished, dedicated, or abandoned.

What is claimed is:

1. A stand alone “Hydro Electric Power Supply System” comprising:
an upper water tank;
a lower water tank, said upper water tank is placed above said lower water tank to create necessary water head;
a water pump;
a first turbine to generate electricity dedicated to power up said water pump to extract water from said lower water tank back up to said upper water tank;
a second turbine to generate electricity for home or business usage; and
a plurality of pipes to create water passage between said upper water tank, said first and second turbine, and said water pump.

2. A stand alone “Hydro Electric Power Supply System” as in claim 1, further comprising a third turbine to generate electricity for home or business usage.

3. A stand alone “Hydro Electric Power Supply System” as in claim 1 or 2, further comprising pipe reducers to create high speed water jet.

4. A stand alone “Hydro Electric Power Supply System” as in claim 1 or 2, wherein said plurality of pipes reduce in diameter as it gets closer to water inlets of said first and second turbine to obtain a high speed water jet.

5. A stand alone “Hydro Electric Power Supply System” as in claim 1 or 2, further comprising a standalone support to place said upper water tank above the ground.

6. A stand alone “Hydro Electric Power Supply System” as in

1. or 2, wherein said lower water tank is placed under ground.

7. A stand alone “Hydro Electric Power Supply System” as in claim 1 or 2, wherein said lower water tank is smaller than said upper water tank in size.

8. A stand alone “Hydro Electric Power Supply System” as in claim 3, further comprising an electronic and float switches mechanism dedicated to said first, second, or third turbine.

9. A stand alone “Hydro Electric Power Supply System” as in claim 8, further comprising emergency shut off mechanism dedicated to said water pump.

10. A stand alone “Hydro Electric Power Supply System” as in claim 9, wherein said water pump is connected to the system backup power supply.

11. A stand alone “Hydro Electric Power Supply System” as in claim 10, wherein said lower water tank is configured with overflow protection.

12. A stand alone “Hydro Electric Power Supply System” as in claim 11, wherein said upper water tank is pre-filled with clean filtered water.
